(19) United States
(12) Patent Application Publication
(10) Pub. No.: US 2020/0106555 A1
(43) Pub. Date: Apr. 2, 2020

(54) MAXIMIZE POWER BOOSTING USING AN INTERLACE DESIGN BASED ON RESOURCE BLOCKS

(71) Applicant: MediaTek Inc., Hsinchu (TW)

(72) Inventors: Chun-Hsuan Kuo, San Jose, CA (US); Jiann-Ching Guey, Hsinchu (TW)

(21) Appl. No.: 16/585,904

(22) Filed: Sep. 27, 2019

Related U.S. Application Data
(60) Provisional application No. 62/737,996, filed on Sep. 28, 2018.

(51) Int. Cl. H04L 1/00; H04W 16/14; H04W 52/34

(52) U.S. Cl. CPC H04L 1/0071; H04L 1/003; H04W 52/34; H04W 16/14; H04L 1/0061

(57) ABSTRACT

A user equipment (UE) transmits an uplink signal in a wireless network which provides an interlace structure in a frequency domain for uplink transmission. The UE identifies a frequency range which is shared by UEs in the wireless network and is partitioned into N interlaces, N being an integer greater than one. Each interlace is formed by a sequence of resource blocks (RBs) that are non-adjacent and equidistant in frequency. According to a first method, the UE transmits the uplink signal combined with a unique bit sequence to a base station in the wireless network. The transmitted uplink signal spreads across all of the N interlaces. According to a second method, the UE transmits the uplink signal using a different one of the N interlaces in each of N consecutive symbol periods.

### CROSS-REFERENCE TO RELATED APPLICATIONS

This application claims the benefit of U.S. Provisional Application No. 62/737,996 filed on Sep. 28, 2018, the entirety of which is incorporated by reference herein.

### TECHNICAL FIELD

Embodiments of the invention relate to wireless communications; more specifically, to frequency allocation for uplink transmissions based on resource block interlacing.

### BACKGROUND

The Fifth Generation New Radio (5G NR) is a telecommunication standard for mobile broadband communications. 5G NR is promulgated by the 3rd Generation Partnership Project (3GPP) to significantly improve on performance metrics such as latency, reliability, throughput, etc. 5G NR supports operations in unlicensed spectrum (NR-U) to provide bandwidth in addition to the mmWave spectrum to mobile users.

In Long Term Evolution (LTE) or Fourth Generation (4G), the 3GPP defined a coexistence path for WiFi and LTE using the unlicensed spectrum (e.g., 2.4 or 5 GHz bands). LTE provides License-Assisted Access (LAA) and enhanced LAA (eLAA), which leverage the unlicensed 5 GHz band in combination with licensed spectrum to deliver a performance boost in downlink (DL) and uplink (UL), respectively. The unlicensed spectrum for 5G NR may potentially include 6 GHz band, covering 5.925 GHz-7.125 GHz, in addition to the LTE unlicensed spectrum. However, it is noted that the unlicensed spectrum in different countries and regions may deviate from what is mentioned above.

Operation in the unlicensed spectrum is subject to power emission requirements that limit signal propagation and in-band interference. One measurement of power emission is Power Spectral Density (PSD). According to the European Telecommunications Standards Institute (ETSI) regulation, in the 5 GHz band, the maximum PSD with transmit power control is 10 dBm/MHz. Furthermore, the ETSI requires that the Occupied Channel Bandwidth (OCB) be between 80% and 100% of the nominal channel bandwidth in the unlicensed 5 GHz band, where the OCB is defined as the bandwidth containing 99% of the signal power.

Imposing the maximum PSD and OCB requirements on 5G terminals can reduce signal interference and promote efficient usage of the bandwidth in the unlicensed spectrum. However, the maximum PSD requirement on a 5G terminal's transmit power significantly constraints its coverage area. Thus, there is a need for addressing the power emission issue for a 5G terminal in the context of established designs for shared usage of the unlicensed spectrum.

### SUMMARY

In one embodiment, a method is provided for transmitting an uplink signal in a wireless network that provides an interlace structure in a frequency domain for uplink transmission. The method comprises obtaining a bit sequence which uniquely identifies a user equipment (UE) among a plurality of UEs in the wireless network. The method further comprises identifying a frequency range which is shared by the UEs and is partitioned into N interlaces, N being an integer greater than one. Each interlace is formed by a sequence of resource blocks (RBs) that are non-adjacent and equidistant in frequency. The method further comprises transmitting the uplink signal combined with the bit sequence from the UE to a base station in the wireless network. The transmitted uplink signal spreads across all of the N interlaces.

In another embodiment, a method performed by a UE in a wireless network is provided. The wireless network provides an interlace structure in a frequency domain for uplink transmission. The method comprises identifying a frequency range which is shared by a plurality of UEs and is partitioned into N interlaces, N being an integer greater than one. Each interlace is formed by a sequence of RBs that are non-adjacent and equidistant in frequency. The method further comprises transmitting an uplink signal using a different one of the N interlaces in each of N consecutive symbol periods.

In other embodiment, a UE in a wireless network is provided. The wireless network provides an interlace structure in a frequency domain for uplink transmission. The UE comprises an antenna; a transceiver coupled to the antenna; one or more processors coupled to the transceiver; and memory coupled to the one or more processors. The UE is operative to perform one or more of the aforementioned methods.

Other aspects and features will become apparent to those ordinarily skilled in the art upon review of the following description of specific embodiments in conjunction with the accompanying figures.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram illustrating a network in which the embodiments of the present invention may be practiced.

FIG. 2 is a diagram illustrating an interlace structure for uplink transmissions according to one embodiment.

FIGS. 3A and 3B are diagrams illustrating frequency allocation scheme according to a first embodiment.

FIG. 4 illustrates a method for uplink transmission according to one embodiment.

FIG. 5 is a diagram illustrating a frequency allocation scheme according to a second embodiment.

FIG. 6 illustrates a method for uplink transmission according to another embodiment.

FIG. 7 is a block diagram illustrating elements of a UE operable to perform uplink transmission according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Disclosed herein are frequency allocation schemes for uplink transmission in the context of interlace structures provided by a wireless network system. The interlace structures promote efficient usage of the bandwidth to thereby satisfy the aforementioned OCB requirement. The disclosed schemes are built on top of the interlace structures for allocating interlaces to UEs such that the UEs can boost their transmit power for uplink transmission while satisfying the aforementioned OCB and maximum PSD requirements.

In one embodiment, the frequency range in connection with the disclosed frequency allocation schemes is in the unlicensed spectrum of a wireless network system. The specific frequency bands of the unlicensed spectrum may differ from one region to another, and may change with the continuous development of the wireless technologies. Thus, it should be understood that the disclosed schemes are not tied to a particular frequency band. The disclosed schemes are provided to comply with the aforementioned OCB and maximum PSD requirements in a wireless network which provides interlace structures in the frequency domain for its users. In some embodiments, such a wireless network may operate according to standards based on 5G NR, LTE, eLAA and/or the like.

The disclosed frequency allocation schemes may be applied to uplink transmissions from a UE to a base station (known as gNodeB in a 5G network). In some examples, uplink transmissions may include transmissions of uplink control information, which may further include, for example, acknowledgements or non-acknowledgements of downlink transmissions, or channel state information. Uplink transmissions may also include transmissions of data, reference signals, and/or contention resolution signals. Uplink signals may be modulated by multiple sub-carriers (e.g., waveform signals of different frequencies) according to various radio technologies.

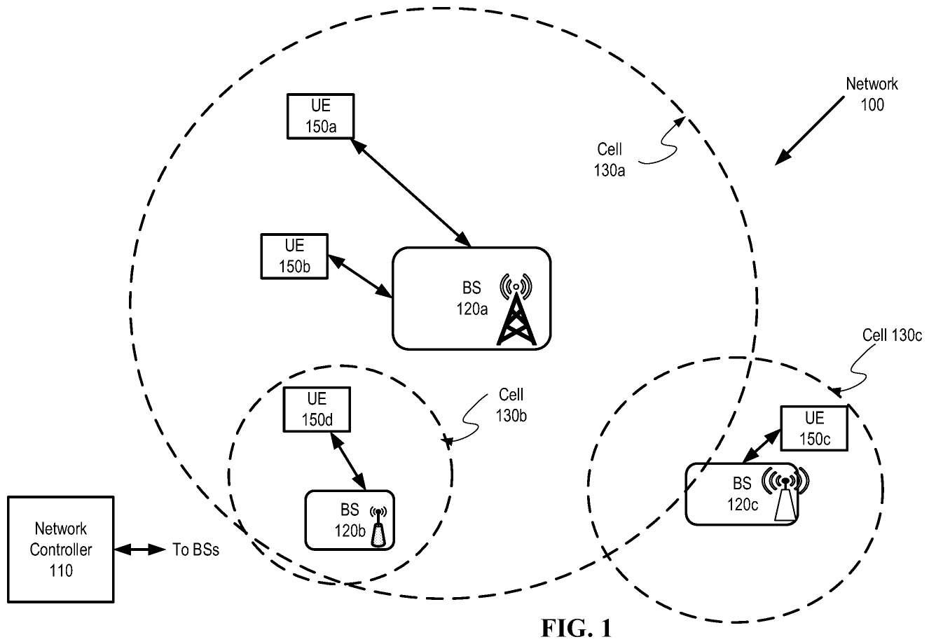

FIG. 1 is a diagram illustrating a network 100 in which the embodiments of the present invention may be practiced. The network 100 is a wireless network which may be a 5G NR network, LTE-based network which provides eLAA, and/or other networks. To simplify the discussion, the methods and apparatuses are described within the context of a 5G NR network. However, one of ordinary skill in the art would understand that the methods and apparatuses described herein are applicable to a variety of other multi-access technologies and the telecommunication standards that employ these technologies.

The number and arrangement of components shown in FIG. 1 are provided as an example. In practice, the network 100 may include additional devices, fewer devices, different devices, or differently arranged devices than those shown in FIG. 1.

Referring to FIG. 1, the network 100 may include a number of base stations (BSs), such as BSs 120a, 120b, and 120c, collectively referred to as the BSs 120. In some network environments such as a 5G NR network, a BS may be known as a gNodeB, a gNB, and/or the like. In an alternative network environment, a BS may be known by other names. Each BS 120 provides communication coverage for a particular geographic area known as a cell, such as a cell 130a, 130b or 130c, collectively referred to as cells 130. The radius of a cell size may range from several kilometers to a few meters. A BS may communicate with one or more other BSs or network entities directly or indirectly via a wireless or wireline backhaul.

A network controller 110 may be coupled to a set of BSs such as the BSs 120 to coordinate, configure, and control these BSs 120. The network controller 110 may communicate with the BSs 120 via a backhaul.

The network 100 further includes a number of user equipment terminals (UEs), such as UEs 150a, 150b, 150c and 150d, collectively referred to as the UEs 150. The UEs 150 may be anywhere in the network 100, and each UE 150 may be stationary or mobile. The UEs 150 may also be known by other names, such as a mobile station, a subscriber unit, and/or the like. Some of the UEs 150 may be implemented as part of a vehicle. Examples of the UEs 150 may include a cellular phone (e.g., a smartphone), a wireless communication device, a handheld device, a laptop computer, a cordless phone, a tablet, a gaming device, a wearable device, an entertainment device, a sensor, an infotainment device, Internet-of-Things (IoT) devices, or any device that can communicate via a wireless medium.

In one embodiment, the UEs 150 may communicate with their respective BSs 120 in their respective cells 130. The transmission from a UE to a BS is called uplink transmission, and from a BS to a UE is called downlink transmission.

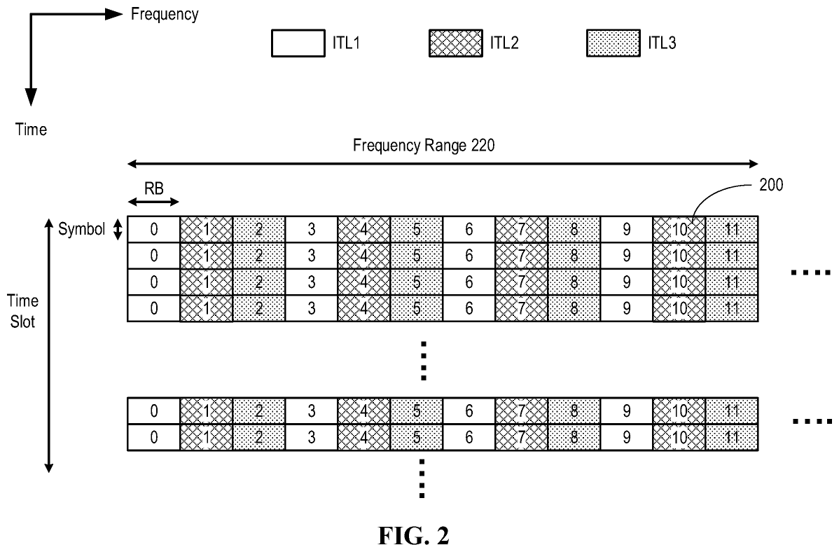

FIG. 2 is a diagram illustrating an example of an interlace structure 200 for uplink transmissions according to one embodiment. In FIG. 2, the time axis extends downwards in the vertical direction and the frequency axis extends to the right in the horizontal direction. Each row of squares represents an interlace structure 200 provided by a wireless network (e.g., the network 100 of FIG. 1) in the frequency domain. Each square represents an RB. The interlace structure 200 spans across a frequency range 220 composed of a contiguous sequence of RBs. The interlace structure 200 includes three interlaces (e.g., ITL1, ITL2 and ITL3) in the frequency range 220, with each interlace indicated by a different pattern fill. The interlace structure 200 has a block-interlaced frequency-division multiple-access (B-IFDMA) structure, which is provided for uplink transmission in order to comply with both OCB and maximum PSD requirements, while at the same time maintaining a transmit signal power level that may support a desired cell coverage.

Multiple time and frequency configurations are supported by NR. With respect to time resources, a frame may be 10 ms in length, and may be divided into ten subframes of 1 ms each. Each subframe may be further divided into multiple equal-length time slots (also referred to as “slots”), and the number of slots per subframe may be different in different configurations 4 slots per subframe). Each slot may be further divided into multiple equal-length symbol periods (also referred to as symbols), and the number of symbols per slot may be different in different configurations (e.g., 14 symbols per slot). In one embodiment, each symbol period may be used to transmit an Orthogonal Frequency-Division Multiplexing (OFDM) symbol.

With respect to frequency resources, NR supports multiple different subcarrier bandwidths (also referred to as subcarrier spacing); e.g., 15 kHz, 30 kHz, 60 kHz or other subcarrier bandwidths. Contiguous subcarriers are grouped into one RB. In one configuration, one RB contains 12 equally-spaced subcarriers, also referred to as resource elements (REs). Multiple RBs (e.g., 4) form one subchannel.

The frequency range allocated to uplink transmission is structured as multiple interlaces of RBs. In the example of FIG. 2, each interlace includes four RBs, any two successive RBs in the same interlace is separated by two RBs of two other interlaces. For example, ITL1 includes RBs 0, 3, 6 and 9; ITL2 includes RBs 1, 4, 7 and 10; and ITL3 includes RBs 2, 5, 8 and 11. The interlace structure 200 may be provided by the network to the UEs for uplink transmission.

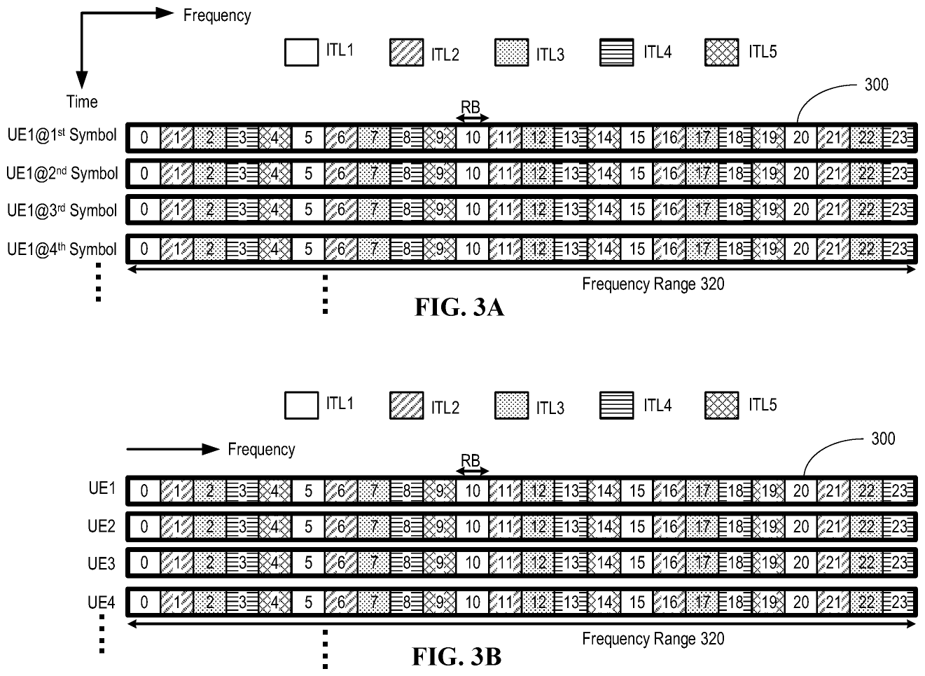

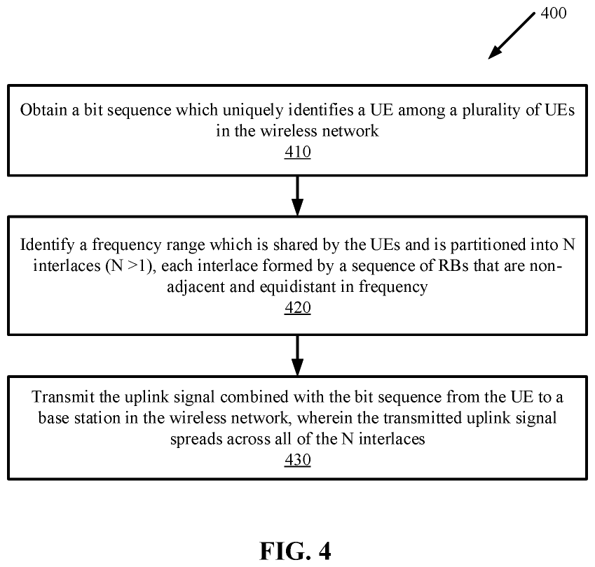

When a UE requests time-and-frequency resources for uplink transmission, the network (e.g., the base station) may grant the UE one of the interlaces for a period of time. When transmitting signals over one interlace (e.g., ITL1), a UE's OCB is calculated as from the start of RB 0 to the end of RB 9, which is over 80% of the nominal channel bandwidth of the frequency range 220. Thus, the interlace structure 200 is designed for the UEs to satisfy the OCB requirement. According embodiments of the invention to be described below with reference to FIGS. 3A, 3B and 4, interlaces may be allocated to a UE according to allocation schemes that enable the UE to boost its uplink transmit power while satisfying both the maximum PSD and OCB requirements.

FIG. 3A illustrates a frequency allocation scheme according to a first embodiment. In FIG. 3A, the time axis extends downwards in the vertical direction and the frequency axis extends to the right in the horizontal direction. Four rows of squares are shown; each row represents an interlace structure 300 provided by a wireless network (e.g.; the network 100 of FIG. 1) in the frequency domain. Each square represents an RB. The interlace structure 300 spans across a frequency range 320 composed of a contiguous sequence of RBs. The interlace structure 300 includes five interlaces (e.g., ITL1, ITL2, ITL3, ITL4 and ITL5) in the frequency range 320, with each interlace indicated by a different pattern fill. FIG. 3A shows the same interlace structure 300 for four contiguous symbol periods. In each of these symbol periods, all of the five interlaces are allocated to UE1.

In this first embodiment, the frequency range 320 may be allocated to one or more UEs. FIG. 3B illustrates the frequency allocation scheme of FIG. 3A when the interlace structure 300 is allocated to a group of UEs according to one embodiment. In FIG. 3B, the frequency axis extends to the right in the horizontal direction. The entire interlace structure 300, composed of five interlaces, is allocated to each UE in a LIE group (including UE1, UE2, UE3, UE4, etc.). That is, each UE in the group is allocated with all five interlaces for uplink transmission. To distinguish the uplink signals transmitted from different UEs, the uplink signal from a UE is combined with a unique (i.e., UE-specific) identifier before transmission. For example, an identifier of a UE may be a pseudo-random (PN) bit sequence, and the UE may combine its uplink signal with the PN bit sequence by a bit-wise XOR operation before transmission. The bit sequence may be chosen to spread the uplink signal across the frequency range 320 to satisfy the OCB requirement. Alternative types of identifiers and/or alternative types of combine operations may also be used.

It is understood that the examples in FIGS. 3A and 3B are illustrative of the first embodiment and not restrictive. According to the first embodiment, a frequency range may be shared by a group of UEs, with each UE identified by a unique bit sequence (also referred to as code). The frequency range may be partitioned into N interlaces, where N is an integer greater than one. Each interlace is formed by a sequence RBs that are non-adjacent and equidistant in frequency. Each UE in the group is allocated with all of the N interlaces in the frequency range, and each RB is the frequency range carries information from all of the UEs in the group. Each UE in the group transmits its uplink signal combined with the UE's unique bit sequence to a base station. The transmitted uplink signal (combined with the bit sequence) from each UE spreads across all of the N interlaces.

In one embodiment, the frequency range may occupy a portion of the unlicensed spectrum for uplink transmission. The unlicensed spectrum, or some portions thereof, may be partitioned into N interlaces of RBs (N is an integer greater than one). However, in this embodiment each UE in the group uses all of the interlaces in the frequency range and may transmit their respective uplink signals to a base station concurrently in the same symbol periods. The uplink signals from different UEs are separated by the base station using the UE-specific code. In one embodiment, the UE-specific code is generated by the base station and communicated to the UE; in an alternative embodiment, the UE generates the UE-specific code and communicates the code to the base station. The bit sequences used by different UEs in the group may be PN bit sequences. In one embodiment, the bit sequences used by different UEs in the group may be orthogonal or quasi-orthogonal to one another.

FIG. 4 illustrates a method 400 for transmitting an uplink signal in a wireless network that provides an interlace structure in the frequency domain for uplink transmission according to one embodiment. The method 400 begins at step 410 when the UE obtains a bit sequence which uniquely identifies the UE among a plurality of UEs in the wireless network. At step 420, the UE identifies a frequency range which is shared by the UEs and is partitioned into N interlaces of RBs, each interlace formed by a sequence RBs that are non-adjacent and equidistant in frequency shared by the plurality of UEs for the uplink transmission. At step 430, the UE transmits an uplink signal combined with the bit sequence to a base station in the wireless network. The transmitted uplink signal spreads across all of the N interlaces. In one embodiment, each of the UEs uses all of the N interlaces for their respective uplink transmissions.

In one embodiment, the wireless network is a 5G NR network, and the frequency range is in the unlicensed spectrum according to the definition provided by NR-U. In one embodiment, an example of the wireless network may be the network 100 of FIG. 1, which may be a 5G NR network, a 4G network, an LTE-based network that provides eLAA, or the like. An example of the interlace structure may be the interlace structure 300 of FIGS. 3A and 3B. Alternative interlace structures having different numbers of RBs and/or different numbers of interlaces may be provided by the wireless network.

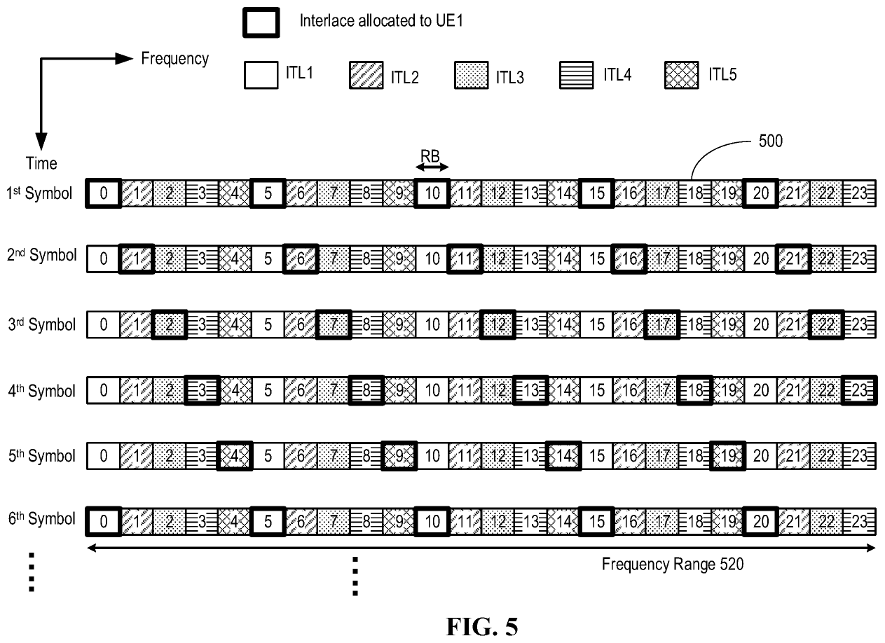

FIG. 5 is a diagram illustrating a frequency allocation scheme according to a second embodiment. In FIG. 5, the time axis extends downwards in the vertical direction and the frequency axis extends to the right in the horizontal direction. Six rows of squares are shown; each row represents an interlace structure 500 provided by a wireless network (e.g., the network 100 of FIG. 1) in the frequency domain. Each square represents an RB. The interlace structure 500 spans across a frequency range 520 composed of a contiguous sequence of RBs. The interlace structure 500 includes five interlaces (e.g., ITL1, ITL2, ITL3, ITL4 and ITL5) in the frequency range 520, with each interlace indicated by a different pattern fill. FIG. 5 shows the same interlace structure 500 for six contiguous symbol periods. The thick outlined squares indicate the interlace allocated to UE1 in each of these symbol periods.

In FIG. 5, the frequency range 520 is partitioned into N interlaces of RBs (N=5 in this example). Each interlace is formed by a sequence RBs that are non-adjacent and equidistant in frequency. For example, ITL1 includes RBs 0, 5, 10, 15 and 20; ITL2 includes RBs 1, 6, 11, 16 and 21; ITL3 includes RBs 2, 7, 12, 17 and 22; ITL4 includes RBs 3, 6, 11, 16 and 23; and ITL4 includes RBs 4, 7, 14, 17 and 24. Any two successive RBs in the same interlace are separated by the RBs of other (N−1) interlaces; e.g., any two successive RBs in ITL1 are separated by four other RBs that respectively belong to four other interlaces.

In a given symbol period, each interlace is allocated to one UE; and different UEs use different interlaces for uplink transmission. That is, the N interlaces in a given symbol period may be allocated to respective ones of the UEs, with each UE allocated with a different one of the N interlaces. Assume that initially (e.g., at a first symbol period), ITL1 is allocated to UE1, ITL2 is allocated to UE2, ITL3 is allocated to UE3, ITL4 is allocated to UE4 and ITL5 is allocated to UE5. Starting with the initial interlace (ITL1), UE1 transmits an uplink signal using a different one of the five interlaces in each subsequent symbol period. For example, UE1 may use ITL1 in a first symbol period, ITL2 in a second symbol period, ITL3 at a third symbol period, ITL4 in a fourth symbol period, and ITL5 in a fifth symbol period. The uplink transmission by UE1 uses N interlaces in N symbol periods (N=5 in the example), but only one interlace in each symbol period. The interlace usage by UE1 follows a cyclic pattern which repeats every N symbol periods.

In one embodiment, the interlace structure provided by a wireless network system may have the same number of RBs for all interlaces in a given frequency range. In another embodiment, the interlace structure provided by a wireless network system may have different numbers of RBs for different interlaces in a given frequency range. That is, at least one of the N interlaces may have a different number of RBs from the others of the N interlaces. In the example of FIG. 5, UE1 is allocated with five RBs at the first, second, third and fourth symbols, and only four RBs at the fifth symbol. In one embodiment, the loss of one RB at a symbol period may be compensated for by error-correction coding, such as forward error correction (FEC). For example, an error-correction code may be calculated and attached to the uplink signal to be transmitted over a number of symbols. The uplink signal, with the error-correction code, is spread over the allocated five RBs at the first, second, third and fourth symbols. At the fifth symbol, the uplink signal with the error-correction code is spread over the four RBs 4, 9, 14 and 19, plus a non-allocated RB (e.g., RB 24 which is outside the allocated frequency range 520). The portion of the uplink signal spread into the non-allocated. RB is not transmitted. At the receiving end, the base station can recover the un-transmitted portion of the uplink signal using the error-correction code.

It is noted that the time and the frequency allocated to uplink transmission are not limited to the aforementioned examples. For example, the number of interlaces in a predefined frequency range, the number of RBs in each interlace, and/or the number of symbols per cycle in the cyclic pattern of FIG. 5 may be different in alternative embodiments.

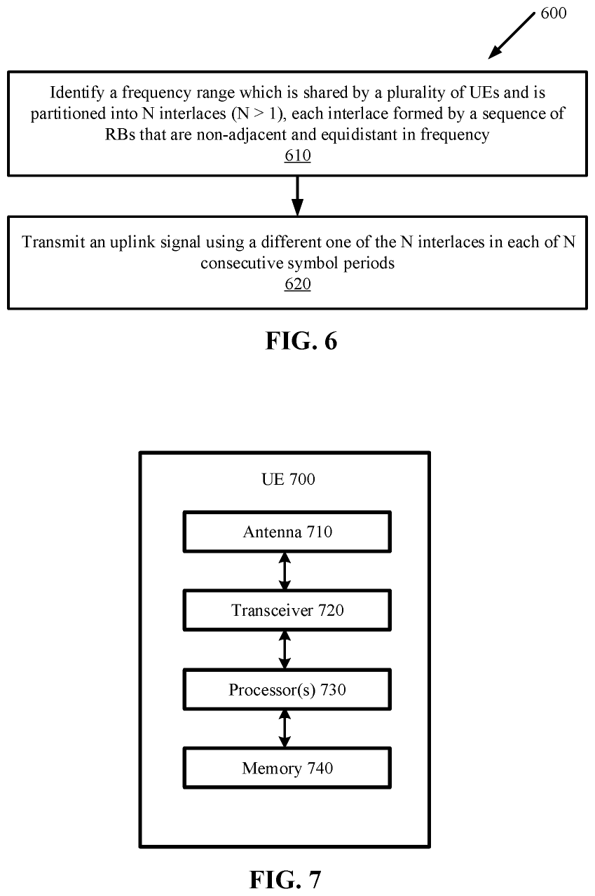

FIG. 6 illustrates a method 600 performed by a UE in a wireless network that provides an interlace structure in the frequency domain for uplink transmission according to one embodiment. The method 600 starts at step 610 when the UE identifies a frequency range which is shared by a plurality of UEs and is partitioned into N interlaces of RBs, N being an integer greater than one. Each interlace is formed by a sequence RBs that are non-adjacent and equidistant in frequency. At step 620, the UE transmits an uplink signal using a different one of the N interlaces in each of N consecutive symbol periods.

In one embodiment, the UE uses a different one of the N interlaces for the uplink transmission according to a cyclic pattern which repeats every fixed interval; e.g., every N symbol periods.

In one embodiment, the wireless network is a 5G NR network, and the frequency range is in the unlicensed spectrum according to the definition provided by NR-U. In one embodiment, an example of the wireless network may be the network 100 of FIG. 1, which may be a 5G NR network, a 4G network, an LTE-based network that provides eLAA, or the like. An example of the interlace structure may be the interlace structure 500 of FIG. 5. Alternative interlace structures having different numbers of RBs and/or different numbers of interlaces may be provided by the wireless network.

The frequency allocation schemes described above in connection with FIGS. 3A, 3B and 5, and their corresponding methods 400 and 600 in FIGS. 4 and 6, boost the transmission power of the UEs. The power boost can be achieved while satisfying the OCB and the maximum PSD requirements. In comparison, another frequency allocation scheme (referred to as a base scheme) may allocate the same single interlace to a UE over an entire allocated time duration of multiple symbols. Using the diagram in FIG. 5, the base scheme may allocate the first interlace (ITL1) to UE1 for each of the six symbol periods shown in FIG. 5. Assume that each RB is composed of twelve 60 kHz sub-carriers. Thus, each RB has a bandwidth of 0.72 MHz. For the purpose of calculating the maximum PSD for UE1, the effective bandwidth for each RB is 1 MHz since there is at most one RB of ITL1 in a 1-MHz window. According to the base scheme and the 10 dBm/MHz maximum PSD requirement, the maximum mean transmission power of the UE would be P_{TX}=10 dBm/MHz+10×log₁₀(5 MHz)=16.9897 dBm. In the first embodiment (FIG. 3A), the maximum mean transmission power of UE1 would be P_{Tx}=10 dBm/MHz+10×log₁₀(24×0.72 MHz)=22.3754 dBm. In the second embodiment (FIG. 5), the maximum mean transmission power of UE1 would also be P_{Tx}=10 dBm/MHz+10×log₁₀(24×0.72 MHz)=22.3754 dBm, because on average all of the 24 RBs are utilized by UE1. Thus, the frequency allocation schemes in both the first and the second embodiments boost the UE transmission power (22.3754 dBm vs. 16.9897 dBm) while satisfying the 10 dBm/MHz maximum PSD requirement. It should be understood that the above calculations are provided for illustrative purpose only. The numbers may be different for different interlace structures and different power emission requirements.

FIG. 7 is a block diagram illustrating elements of a UE 700 (also referred to as a wireless device, a wireless communication device, a wireless terminal, etc.) configured to provide uplink transmission according to one embodiment. As shown, the UE 700 may include an antenna 710, and a transceiver circuit (also referred to as a transceiver 720) including a transmitter and a receiver configured to provide at least uplink and downlink radio communications with a base station of a radio access network. The UE 700 may also include a processor circuit (which is shown as a processor 730 and which may include one or more processors) coupled to the transceiver 720. The processor(s) 730 may include one or more processor cores. The UE 700 may also include a memory circuit (also referred to as memory 740) coupled to the processor 730. The memory 740 may include computer-readable program code that when executed by the processor 730 causes the processor 730 to perform operations according to embodiments disclosed herein, such as the method 400 in FIG. 4 and the method 600 in FIG. 6. The UE 700 may also include an interface (such as a user interface). It is understood the embodiment of FIG. 7 is simplified for illustration purposes. Additional hardware components may be included.

Although the UE 700 is used in this disclosure as an example, it is understood that the methodology described herein is applicable to any computing and/or communication device capable of transmitting uplink signals to a base station.

The operations of the flow diagrams of FIGS. 4 and 6 have been described with reference to the exemplary embodiments of FIGS. 1 and 7. However, it should be understood that the operations of the flow diagrams of FIGS. 4 and 6 can be performed by embodiments of the invention other than the embodiments of FIGS. 1 and 7, and the embodiments of FIGS. 1 and 7 can perform operations different than those discussed with reference to the flow diagrams. While the flow diagrams of FIGS. 4 and 6 show a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits, or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for transmitting an uplink signal in a wireless network that provides an interlace structure in a frequency domain for uplink transmission, comprising:
obtaining a bit sequence which uniquely identifies a user equipment (UE) among a plurality of UEs in the wireless network;
identifying a frequency range which is shared by the UEs and is partitioned into N interlaces, N being an integer greater than one, each interlace formed by a sequence of resource blocks (RBs) that are non-adjacent and equidistant in frequency; and
transmitting the uplink signal combined with the bit sequence from the UE to a base station in the wireless network, wherein the transmitted uplink signal spreads across all of the N interlaces.

2. The method of claim 1, wherein the bit sequence is a pseudo-random (PR) bit sequence, an orthogonal bit sequence, or a quasi-orthogonal bit sequence.

3. The method of claim 1, wherein each RB in the frequency range carries information from all of the UEs.

4. The method of claim 1, wherein the frequency range is in an unlicensed spectrum of a Fifth-Generation New Radio (5G NR) wireless network.

5. The method of claim 1, wherein the frequency range is in an unlicensed spectrum of a Long Term Evolution (LTE)-based wireless network.

6. A method performed by a user equipment (UE) in a wireless network that provides an interlace structure in a frequency domain for uplink transmission, comprising:
identifying a frequency range which is shared by a plurality of UEs and is partitioned into N interlaces, N being an integer greater than one, each interlace formed by a sequence of resource blocks (RBs) that are non-adjacent and equidistant in frequency; and
transmitting an uplink signal using a different one of the N interlaces in each of N consecutive symbol periods.

7. The method of claim 6, wherein the UE uses the N interlaces according to a cyclic pattern which repeats every N symbol periods.

8. The method of claim 6, wherein the N interlaces in a given symbol period are allocated to respective ones of the UEs, with each UE allocated with a different one of the N interlaces.

9. The method of claim 6, further comprising:
transmitting the uplink signal with error-correction code using the different one of the N interlaces in each of N consecutive symbol periods, wherein at least one of the N interlaces has a different number of RBs from others of the N interlaces.

10. The method of claim 6, wherein the frequency range is in an unlicensed spectrum of a Fifth-Generation New Radio (5G NR) wireless network or a Long Term Evolution (LTE)-based wireless network.

11. A user equipment (UE) in a wireless network that provides an interlace structure in a frequency domain for uplink transmission, comprising:
an antenna;
a transceiver coupled to the antenna;
one or more processors coupled to the transceiver; and
memory coupled to the one or more processors, wherein the UE is operative to:
obtain a bit sequence which uniquely identifies the UE among a plurality of UEs in the wireless network;
identify a frequency range which is shared by the UEs and is partitioned into N interlaces, each interlace formed by a sequence resource blocks (RBs) that are non-adjacent and equidistant in frequency; and
transmit an uplink signal combined with the bit sequence to a base station in the wireless network, wherein the transmitted uplink signal spreads across all of the N interlaces.

12. The UE of claim 11, wherein the bit sequence is a pseudo-random (PR) bit sequence, an orthogonal bit sequence, or a quasi-orthogonal bit sequence.

13. The UE of claim 11, wherein each RB in the frequency range carries information from all of the UEs.

14. The UE of claim 11, wherein the frequency range is in an unlicensed spectrum of a Fifth-Generation New Radio (5G NR) wireless network.

15. The UE of claim 11, wherein the frequency range is in an unlicensed spectrum of a Long Term Evolution (LTE)-based wireless network.

16. A user equipment (UE) in a wireless network that provides an interlace structure in a frequency domain for uplink transmission, comprising:
an antenna;
a transceiver coupled to the antenna;
one or more processors coupled to the transceiver; and
memory coupled to the one or more processors, wherein the UE is operative to:
identify a frequency range which is shared by a plurality of UEs and is partitioned into N interlaces, each interlace formed by a sequence resource blocks (RBs) that are non-adjacent and equidistant in frequency; and
transmit an uplink signal using a different one of the N interlaces in each of N consecutive symbol periods.

17. The UE of claim 16, wherein the UE is operative to use the N interlaces according to a cyclic pattern which repeats every N symbol periods.

18. The UE of claim 16, wherein the N interlaces in a given symbol period are allocated to respective ones of the UEs, with each UE allocated with a different one of the N interlaces.

19. The UE of claim 16, wherein the UE is operative to transmit the uplink signal with error-correction code using the different one of the N interlaces in each of N consecutive symbol periods, wherein at least one of the N interlaces has a different number of RBs from others of the N interlaces.

20. The UE of claim 16, wherein the frequency range is in an unlicensed spectrum of a Fifth-Generation New Radio (5G NR) wireless network or a Long Term Evolution (LTE)-based wireless network.
